(19) United States
(12) Patent Application Publication
(10) Pub. No.: US 2009/0134025 A1
(43) Pub. Date: May 28, 2009

(54) Scanning device with a probe having an organic material

(76) Inventors: Max Shtein, Ann Arbor, MI (US); Kevin P. Pipe, Coldwater, MI (US); Kwang Hyup An, Ann Arbor, MI (US); Yiying Zhao, Ann Arbor, MI (US); Brendan T. O'Connor, Ann Arbor, MI (US)

Correspondence Address: HARNESS, DICKEY & PIERCE, P.L.C., P.O. BOX 828, BLOOMFIELD HILLS, MI, 48303, US

(21) Appl. No.: 11/900,430

(22) Filed: Sep. 12, 2007

Related U.S. Application Data
(60) Provisional application No. 60/843,862, filed on Sep. 12, 2006.

(51) Int. Cl. G01N 27/26; G01N 23/00; B05D 5/12; G12B 21/00

(52) U.S. Cl. 204/407; 250/306; 850/56; 427/70; 427/596; 427/331

(57) ABSTRACT

A probe for a scanning device having an anode, a cathode, and an organic material. The organic material is positioned between the anode and the cathode. The organic material is operable for at least one of emitting and detecting light by an electrical bias applied between the anode and the cathode.

### CROSS REFERENCE TO RELATED APPLICATION(S)

This application claims the benefit of U.S. Provisional Application No. 60/843,862, filed Sep. 12, 2006, the disclosure of which is incorporated herein by reference.

### GOVERNMENT RIGHTS

This invention was made with government support under Contract No. N00014-05-1-0713 awarded by the Office of Naval Research, and under Contract No. ECS-0523986 awarded by the National Science Foundation. The Government has certain rights in the invention.

### FIELD

The following relates to a scanning device and, more particularly, relates to a scanning device with a probe having an organic material.

### BACKGROUND

The statements in this section merely provide background information related to the present disclosure and may not constitute prior art.

Micro-scale optical microscopy techniques such as scanning near-field optical microscopy (SNOM)—a specific type of scanning probe microscopy (other types also include atomic force microscopy (AFM) and scanning tunneling microscopy (STM))—have been proposed for the study of nanostructured semiconductor, ferromagnetic, photonic, biological, and single molecule systems. SNOM is primarily an optically-pumped technique, with the two most standard realizations being aperture-based and apertureless probe architectures. In aperture-based SNOM, for instance, light is coupled to a sample through a hollow pyramid or through a pulled optical fiber with a partially etched metal cladding.

Scanning near-field optical microscopy (SNOM) has been used with some success for both topographic and fluorescence measurements of materials on a sub-wavelength spatial scale. Two substantial considerations for successful SNOM are optical pumping and the creation of a highly confined optical field. Furthermore, in aperture-based SNOM, high temperatures can damage sensitive samples and problems can occur with the characterization of sample surface morphology. In apertureless SNOM probes, light typically floods a metallized probe tip, exciting surface plasmons at the tip, with the evanescent field coupling to a sample. Moreover, for apertureless SNOM, the resolution is limited by a combination of the aperture or tip size and the sensitivity of the detector. In addition, in apertureless SNOM, the sample is typically flooded with light, which greatly reduces the signal-to-noise ratio.

While there have been several attempts to provide an electrically pumped micro-scale light source, these attempts have suffered from significant limitations that reduce their practical use as scanning probes. For example, a micro-fabricated optical probe having a light-emitting diode (LED) glued to the cantilever, waveguide, and aperture has been proposed; however, since the LED is not integrally attached, but rather glued to the cantilever, the design is less robust than generally necessary for practical use on a scanning probe tip, and can be costly to fabricate. Another scanning probe having a GaAs vertical cavity surface emitting laser (VCSEL) probe integrated with a GaAs cantilever has been proposed having an 80 nm imaging resolution. However, while the direct band-gap III-V materials have favorable light emission properties, it is difficult to grow such materials with high optical quality on silicon (Si)—the most common material used for fabricating scanning probes—due to lattice mismatch and the formation of antiphase domains. Scanning probe cantilevers made from III-V materials are difficult to fabricate and typically show low yield compared to standard Si micro-machining techniques which enable batch fabrication.

### SUMMARY

According to the principles of the present teachings, a probe for a scanning device is disclosed that includes an anode, a cathode, and an organic material. The organic material can be provided between the anode and the cathode. The organic material is operable for at least one of emitting and detecting light by an electrical bias applied between the anode and the cathode.

A method of forming a probe for a scanning device that at least one of detects and emits light is also disclosed. The method can include providing a substrate and depositing an organic material on the substrate via a process selected from a group consisting of vapor deposition, vacuum deposition, pulsed laser deposition, dip-coating, vacuum thermal evaporation, and a combination thereof.

Furthermore, a scanning device is disclosed that includes at least one probe having an anode, a cathode, and an organic material provided between the anode and the cathode. The organic material is operable for at least one of emitting and detecting light due to at least one of charge injection to and separation from the anode and the cathode.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1A is a perspective view a scanning device having a plurality of probes in accordance with some embodiments of the present disclosure;

FIG. 1B is a cross sectional view of a probe of the scanning device of FIG. 1A;

FIGS. 2A and 2B are sectional views of the probe in accordance with some embodiments of the present disclosure, wherein energy is transported to a sample by surface plasmon mediated coupling;

FIG. 3 is a schematic sectional view of the probe of the scanning device according to some embodiments;

FIG. 4 is a graph illustrating a current-voltage relationship of a layered structure on the scanning probe;

FIG. 5A is a graph illustrating a decay rate change according to a dielectric constant of a sample, showing the effect of ETL thickness (D);

FIG. 5B is a graph of simulated dispersion data;

FIG. 6A is a sectional view of the probe of the scanning device according to some embodiments;

FIG. 6B is a graph showing a current-voltage relationship of the probe of the scanning device;

FIG. 6C is a graph showing current density as a function of organic coverage fraction;

FIG. 7 is a sectional view of the probe of the scanning device according to some embodiments;

FIG. 8A is a top view of the probe of FIG. 7;

FIG. 8B is a top view of the probe of FIG. 7 under forward bias, showing electroluminescence;

FIG. 8C is a graph of current-voltage relationship for the probe of FIG. 7;

FIGS. 9A and 9B are sectional views of the probe according to the present disclosure according to some embodiments;

FIGS. 10A and 10B are detailed sectional views of the embodiment of FIGS. 9A and 9B;

FIGS. 11A and 11B are side views of the probe, illustrating an embodiment of a fabrication method of the probe; and

FIGS. 12A and 12B are side views of the probe according to the present disclosure.

### DETAILED DESCRIPTION

The following description is merely exemplary in nature and is not intended to limit the present disclosure, application, or uses.

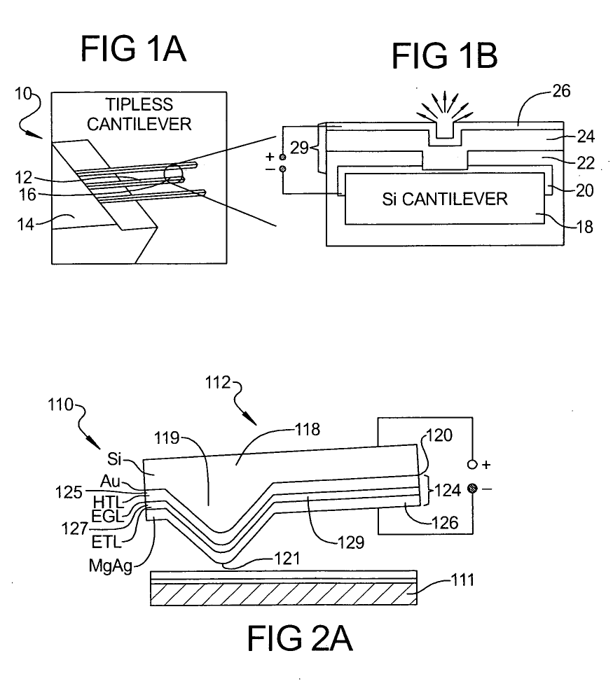

Referring initially to FIGS. 1A and 1B, a scanning device 10 is illustrated. As shown, the scanning device 10 includes at least one probe 12. In the embodiment shown, the scanning device 10 includes a plurality (e.g., three) of probes 12. The probes 12 are elongate and extend linearly outward from a mount 14 so as to have a cantilever-type profile. In one embodiment, each probe has a width of approximately 35 μm. As will be described below, the probes 12 are operable for emitting light and/or absorbing light to thereby detect a characteristic of a target sample (not shown).

Each probe 12 defines a tip 16 spaced from the mount 14. The tip 16 includes a localized area that is represented in cross section in FIG. 1B. Generally, each probe 12 includes a plurality of layers deposited sequentially as described in greater detail below.

More specifically, the probe 12 includes a substrate 18. In one embodiment, the substrate 18 is made out of silicon, silicon-nitride, or other cantilever substrate. The probe 12 also includes a first electrode 20 (e.g., an anode) deposited on the substrate 18. In the embodiment shown, the first electrode 20 disposed adjacent to the substrate 18 is an anode. In one embodiment, the substrate 18 itself functions as the first electrode 20.

Furthermore, the probe 12 includes an electrically insulative insulating layer 22. The insulating layer 22 is supported by and encapsulates the substrate 18 and the first electrode 20 in the embodiment shown. The insulating layer 22 includes a hole 23 that provides access to the first electrode 20. In one embodiment, the hole 23 is formed so as to have a disk-like shape, and the width of the hole 23 measures approximately 6 μm. The insulating layer 22 provides desired electrical isolation in select regions, for instance, to define selected electrical contact regions and to prevent short-circuiting and the like. In one embodiment, the insulating layer 22 is deposited by vapor- and/or vacuum-based methods. Additionally, in one embodiment the insulating layer 22 is made out of para-chloroxylylene, otherwise known as PARYLENE-C™.

In certain other aspects, the probe further comprises an encapsulating layer.

The probe 12 additionally includes an organic material (i.e., an organic film) 24 provided on the insulating layer 22 and provided in the hole 23 so as to be in electrical contact with the first electrode 20. In one embodiment, the organic film 24 is made out of a single layer of material. In another embodiment, the organic film 24 is made out of a plurality of distinct layers of material deposited sequentially. The organic film 24 is an electroluminescent organic film in one embodiment. Also, in one embodiment, the organic film 24 is an optically absorbing organic film.

Moreover, the probe 12 includes a second electrode 26 (e.g., a cathode) provided on and in electrical contact with the organic film 24. The second electrode 26 has an opposite polarity to the first electrode 20. In the embodiment shown, the second electrode 26 is a cathode.

The first and second electrodes 20, 26 may be made out of any suitable material. In one embodiment, the electrodes 20, 26 each include various layers of metals, such as gold, platinum, silver, or aluminum, nickel, magnesium, and alloys thereof, such as alloys of magnesium and silver. Further, in one embodiment, the electrodes 20, 26 further include an interface layer that promotes injection of electrons (e.g. thin lithium or LiF layers) or holes (e.g. high work-function materials). For example, while not limiting as to the electrode compositions, in certain embodiments, the anode 20 comprises aluminum, coated by nickel and/or nickel oxide, or silver, or gold. In one particular example, the anode 20 comprises aluminum thermally deposited at a thickness of about 100 nm, which is then overlaid with nickel at about 10 to about 15 nm thickness. The cathode 26 comprises aluminum, silver, magnesium, and optionally an interface layer. For example, in one embodiment, the cathode 26 comprises LiF deposited at a thickness of approximately 0.5 nm, aluminum having an approximately 1 nm thickness, and silver having approximately an 18 nm thickness.

As will be described in greater detail below, the organic film 24 is operable for emitting and/or detecting light by injection and/or separation of charge due to an electrical bias applied between the first and second electrodes 20, 26. In other words, the organic film 24 is operable for emitting and/or detecting light due charge injection to and/or separation from the electrodes 20, 26.

The organic film 24 can be made of any suitable material. In one embodiment, the organic film 24 is made of at least one well known emitting luminescent dye. In one embodiment, the organic film 24 is made of at least one material chosen from the following: N,N′-di-[(1-napthalenyl]-N,N′-diphenyl]-(1,1′-biphenyl)-4,4′-diamine) (α-NPD), N,N-diphenyl-N,N-di(3-methylphenyl)-1,1-biphenyl-4,4,-diamine (TPD), tris(8-hydroxyquinoline aluminum (Alq₃), platinum octaethyl porphorin (PtOEP), iridium-pyridine (Ir(ppy)₃), and mixtures and combinations thereof. However, other electroluminescent dyes known or to be developed by those of skill in the art are contemplated by the present disclosure.

As used herein, the term OLED 29 refers to a combination of the organic film 24, anode 20, and cathode 26 that generates light. In certain embodiments, the scanning probe 12 is an electrically-pumped microscale light source based on molecular OLEDs 29 deposited directly onto a conventional substrate 18 such as conventional silicon scanning probe cantilevers.

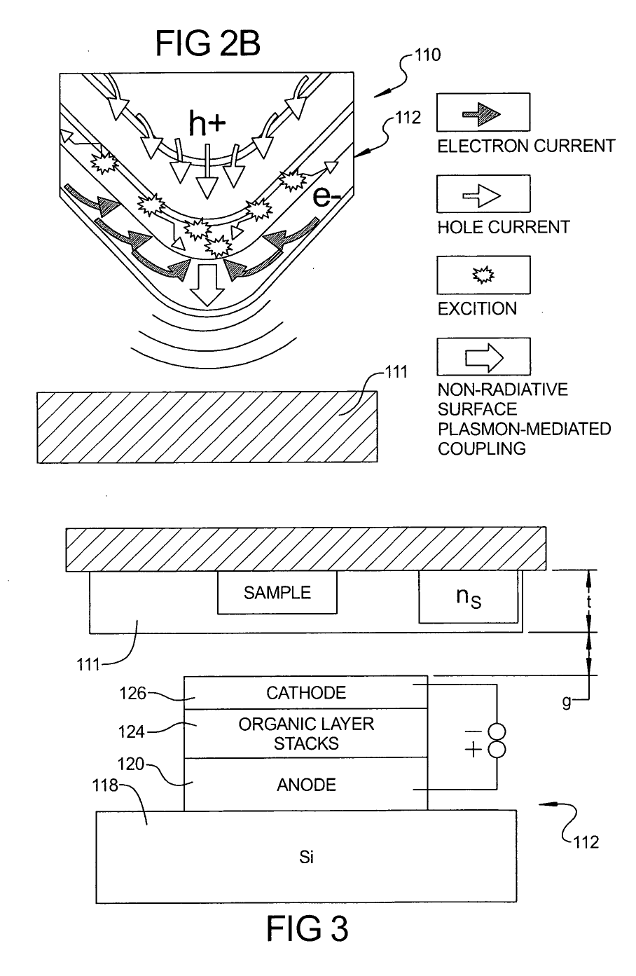

Referring now to FIG. 2A, another embodiment is illustrated, which includes components that are substantially similar to those of FIG. 1B. Components in FIG. 2A corresponding to those of FIG. 1B are indicated with corresponding reference numerals increased by 100.

In the embodiment of FIG. 2A, the probe 112 includes a projection 119. In the embodiment shown, the projection 119 is shaped like a pyramid and extends outward so as to define a narrow tip 121. The projection 119 allows the tip 121 to be positioned relatively close to a sample 111 as will be discussed in greater detail below. Also, the probe 112 includes a substrate 118, an anode 120, an organic film 124, and a cathode 126.

The organic film 124 includes at least two distinct layers. Specifically, in the embodiment shown, the organic film 124 includes a hole transporting layer (HTL) 125 and an electron transporting layer (ETL) 127. The organic film 124 may further comprise a plurality of distinct HTL or ETL layers 125, 127, each having the same or different compositions. It will be appreciated, however, that the organic film 124 can comprise a single layer of organic material without departing from the scope of the present disclosure. For instance, the single organic film layer could be made of a material that supports bipolar injection and recombination.

In one embodiment, α-NPD and TPD are used for forming the hole transporting layer 125. Also, in one embodiment, Alq₃ forms the electron transporting layer 127. Moreover, in one embodiment, the probe 112 includes emitter materials such as PtOEP and Ir(ppy)₃. In one embodiment, these emitter materials are doped into a host, so as to increase their quantum yield. Additional materials may also be included, which function as blocking layers. For instance, bathocuproine (BCP) may be included as a hole- or exciton-blocking layer, to further balance carrier injection and control the position of the exciton generation zone.

In order to manufacture the probe 12, 112, the first electrode 20, 120 is deposited on the substrate 18, 118. In one embodiment, the first electrode 20, 120 is deposited onto the substrate 18, 118 by a conventional deposition process known to those of skill in the art, such as vapor deposition, vacuum deposition, sputtering, and the like.

In one embodiment, the organic film 24, 124 is formed and deposited on the first electrode 20, 120 by vapor deposition, vacuum deposition, pulsed laser deposition, dip-coating, vacuum thermal evaporation or a combination thereof. The organic film 24, 124 is deposited over the first electrode 20, 120 so as to be in electrical contact therewith. It will be appreciated that the organic film 24, 124 provides an additional degree of freedom in tuning the spectral characteristics of the scanning probe 12, 112.

After the deposition of the organic film 24, 124, the second electrode 26, 126 is formed over and in electrical contact with at least a portion of the organic film 24, 124. The material (e.g., silver) and thickness (e.g., 60 nm) of the second electrode 26, 126 may be selected to optimize and support surface plasmon resonance, rather than simply maximizing the efflux of visible photons.

Thus, the present disclosure provides a method of forming a probe 12, 112 for a scanning device 10, 110 that detects and/or emits light, comprising: depositing an electroluminescent organic film 24, 124 on a substrate 18, 118 of the probe 12, 112 via a process selected from the group consisting of: vapor deposition, vacuum deposition, or combinations thereof.

In the embodiments shown, at least a portion of the first electrode 20, 120 on the substrate 18, 118 is overlaid with the electrically insulating material 22 prior to deposition of the electroluminescent organic film 24, 124. Where an electrically insulating material 22 is formed over the first electrode 20, 120, one or more electrically active areas (e.g., the hole 23) are created in the electrically insulating material 22 to establish electrical contact between the first electrode 20, 120 and the electroluminescent organic film 24, 124. Such electrically active regions can be formed by a process selected from the group consisting of: focused ion beam (FIB) milling, electron beam lithography, laser drilling, or combinations thereof. FIB milling defines nanoscale bipolar current injection regions in targeted active organic layers by milling through the insulating material 22 with a beam of ions, for example, gallium ions. For example, a ring-shaped emissive region with a diameter of 5 micrometers and a thickness below the optical emission wavelength can be achieved. Milling depth control, which can be important for optimal optoelectronic device performance, is also achieved by in-situ elemental analysis. Such solvent-free FIB and vapor deposition techniques are widely applicable for use in the design and fabrication of various organic semiconductor-based devices. The work function of the anode 20, 120 can further be modified by ion implantation during FIB milling to improve the charge injection efficiency of the pumped light emitter.

In various aspects, the electroluminescent organic film 24, 124 is deposited in electrical contact with the first electrode 20, 120. In certain aspects, the organic film 24, 124 comprises a plurality of layers deposited sequentially, including, for example, distinct HTL and ETL layers 125, 127. Each of the HTL or ETL layers 125, 127 may comprise several compositionally distinct material layers or several layers having the same composition. Other materials, such as exciton blocking materials can also be applied between the sequential layering of the electroluminescent organic materials.

After the electroluminescent organic film 24, 124 has been deposited, the second electrode 26, 126 having an opposite polarity to the first electrode 20, 120 is formed over and in electrical contact with at least a portion of the electroluminescent organic film 24, 124. As described above, the second electrode 26, 126 can be formed by a deposition process in a similar manner to the first electrode 20, 120.

As shown in FIG. 2, the OLED 129 can generate electrically-pumped excitons at a controlled rate. Such a bilayer OLED 129 comprises a hole transport layer (HTL) 125, an electron transport layer (ETL) 127, and two metal layers (i.e., the anode 120 and the cathode 126). The position of the emitting region, the electroluminescent organic film 124, can be controlled by adjusting the thickness of the HTL and ETL 125, 127 within the bounds set by carrier mobilities. The positioning of the emitting layer can be important for maximizing decay rate change to correspond adequately with the boundary conditions.

There are several advantages of using the organic film 24, 124 for electrical pumping. Electrical pumping reduces light contamination ordinarily occurring with conventional high-resolution apertureless NSOM techniques. Organic emitters permit the tuning of the photon energy, as well as the generation of triplet excitons for radiationless resonant energy transfer to the sample. The latter is an important measurement tool for determining individual exciton dynamics within a sample material or device without the population averaging inherent in conventional measurement methods.

While nanostructured organic and hybrid organic/inorganic materials have shown great promise in applications such as photovoltaics and electronics, nanoscale characterization of these materials has been challenging from both a practical and a theoretical point of view. In particular, in devices like organic light emitting diodes and photovoltaic (PV) cells, the precise positioning of organic-organic and organic-inorganic interfaces control the flow of charge and energy. In the case of organic photovoltaic cells, a highly folded interface between the electron donor and the electron acceptor layers can increase the power conversion efficiency by nearly a factor of 3 over a flat interface using the same material system. However, the different organic layers are only tens of nanometers thick and have very similar electron scattering cross-sections, which make it difficult to ascertain the precise shape of the buried donor-acceptor interface. For example, transmission electron microscopy does not differentiate between the different organic compounds used in a PV cell.

The probe 12, 112 for the scanning device 10, 110 of the type described above has several unique properties, which overcome these various limitations, thus providing a robust scanning probe 12, 112 having good spatial resolution. In certain aspects, the probe current can vary with the optical properties of the sample (such as dielectric constant). In other aspects, the probe 12, 112 can characterize phase separation, crystallization, and the like, in materials synthesis and devices. In addition, such a probe 12, 112 can optionally be used to resonantly transfer exciton (bound electron-hole pair) energy to a sample, for both singlet and triplet excitons, with non-limiting applications in the nanoscale characterization of photovoltaics. For example, such a probe 12, 112 can be used to transfer excitons to a sample with spatial resolution on the order of nanometers to study nanoscale transport processes at the interfaces of organic/inorganic hybrid photovoltaics. Additional applications exist in the area of biological imaging, in which the probe can be used to excite fluorescent markers, whether by photon production or by near-field exciton coupling.

As described above, the probe 12, 112 is provided for a scanning device 10, 110 that detects and/or emits light. The probe 12, 112 includes an anode 20, 120, a cathode 26, 126, and an organic film 24, 124. In one embodiment, the probe 12, 112 is an electrically pumped organic heterostructure disposed on a scanning probe cantilever.

Thus, the probes 12, 112 are light emitting devices based on thin films of organic compounds. Such organic materials can be deposited onto a variety of substrates 18, 118 without the lattice-matching constraints of conventional covalently bonded semiconductors. The availability of a wide range of luminescent dyes, known to those of skill in the art, provides an additional degree of freedom in tuning the spectral characteristics of the organic light emitting device (OLED) 29, 129, which makes such OLEDs 29, 129 particularly suitable for integration with the well-established atomic force microscopy (AFM) scanning probe platform.

The method of fabrication of the OLED 29, 129 directly on the cantilever substrate 18, 118 provides the ability to define an electrical contact and an emissive region which are much smaller than the width of the probe 12, 112 and finer yet to enable high resolution imaging.

Nanoscale OLEDs can be formed on relatively large planar substrates, including: vacuum-deposited OLEDs on broad-area indium tin oxide (ITO) substrates with a spin-coated and pre-patterned insulator layer; spin-coating a polymer emitter into small wells in silicon nitride on a planar conducting substrate, followed by deposition of a cathode; and combining electron beam lithography and spin-coating to make a 100 nm diameter device in a silicon dioxide well on ITO. However, these methods of making OLEDs on scanning probes can have undesirable surface tension effects and/or probe fragility, making the spin-coating process difficult for placing either e-beam resist or active organic layers onto a scanning probe cantilever. It is desirable to be able to coat the silicon-containing cantilever substrate 18, 118 with the electroluminescent organic film 24, 124 without physically damaging the substrate 18, 118, while maintaining a desirable interface between substrate 18, 118 and the OLED 29, 129 via desirable surface tension properties.

In accordance with the present disclosure, an electrically pumped light emitter material (the electroluminescent organic material) is deposited onto a scanning probe cantilever using vapor- and/or vacuum-deposition processes, while the emissive region of the OLED 29, 129 is defined through the use of focused ion beam milling and/or electron beam lithography. The use of such focused ion beam (FIB) milling allows nanoscale features to be patterned on substrates and active device structures that may otherwise be damaged by typical lithographic processes such as spin-coating of resist. This capability can be especially advantageous for defining features on non-traditional substrates and integrating a broad range of materials.

Accordingly, the probe 12, 112 detects and/or emits light and is employed for scanning in an atomic force microscopy (AFM) device. In certain aspects, the scanning device is a scanning near-field optical microscope (SNOM) that is electrically, rather than optically, pumped.

The probe 112 is electrically pumped and in certain aspects, the organic film 124 generates excitons, as is schematically demonstrated in FIGS. 2A and 2B. Such excitons generated in the organic film 124 are capable of transferring energy to the sample 111 via surface plasmon polaritons (SPP). Energy from an excited dipole near a thin metal film is resonantly transferred across the metal film to a dielectric medium in a process mediated by the SPPs. The decay of dipoles within the organic film 124 from an electrically pumped organic emitter results in either outcoupled light, power loss to guided modes (including SPP modes), or loss as heat to one of the electrodes 120, 126 in the vicinity of the metal surface. Among these decay paths, the coupling of the source to SPPs plays a substantial role, where SPP mediated energy transfer from the organic film 124 dipole to a dielectric medium results in over 70% of the total energy dissipated in a microcavity structure. SPPs result from the coupling between the free charges at the surface of a metal and electromagnetic (EM) radiation. This interaction leads to longitudinal surface charge density fluctuations that propagate along the interface combined with an oscillating EM field that decays exponentially away from the metallic surface. It is believed that the coupled SPPs provide resonant energy transfer through up to 120 nm thickness metal film.

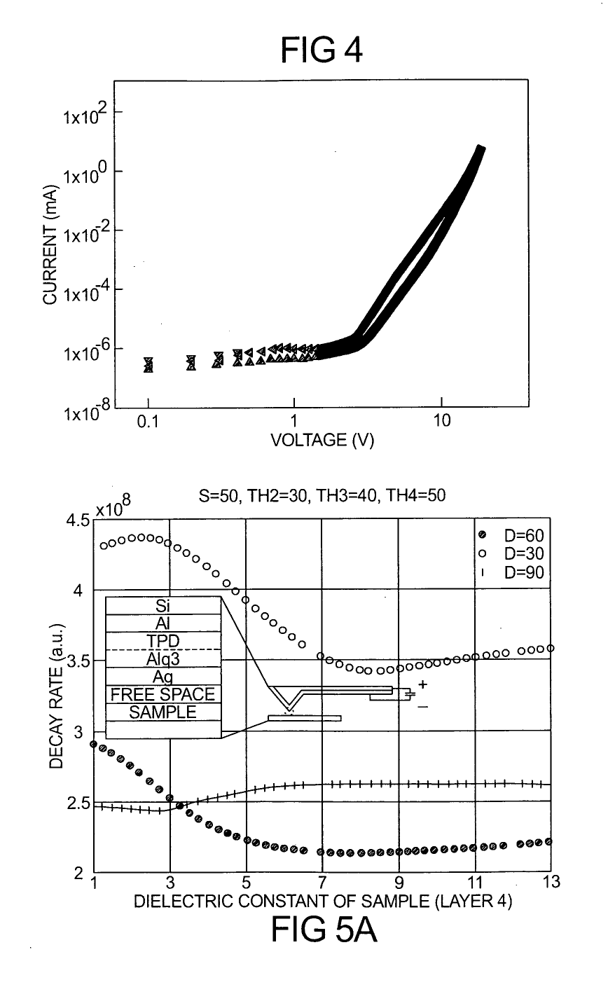

Such an energy transfer mechanism—including the effect of the dielectric film on the dipole's decay rate and hence, the current-voltage relationship for the organic heterostructure (see FIG. 4)—can be employed to optimize operation of the scanning probe 112. For example, where the energy applied to the probe 112 is held at a constant voltage, the variation of current through the heterostructure as the probe tip approaches the sample 111 is dependent on optical properties of the sample 111, such as dielectric constant. This scanning probe technology can also optionally be used to inject excitons into a sample 111 with nanoscale spatial resolution.

Thus, these SPP modes can then couple to the sample 111 at a rate dependent on the sample's optical and electronic properties. In one embodiment, the current-voltage relationship of the probe 112 is dependent on the dipole lifetime (inverse of the decay rate) and hence, the variations in the sample properties, over which the probe 112 is scanned. In one embodiment, the current of the probe 112 varies with the SPP coupling rate and sample variations. This forms the basis for a measurement technique, in which it is unnecessary to correlate the optical signal from the probe 112 or sample 111 to the probe position; rather, the position of the probe 112 is correlated with the electrical current through the probe 112.

The decay rate for dipoles coupled to SPPs changes with the dielectric constant of the sample 111 (situated on the other side of the metal cathode 126) and with the distance from the metal cathode 126 to the sample 111. In one embodiment, for a curved surface such as an AFM with a small tip radius, the decay rate ranges from about 0.2 to more than 1500 times the free-space value, depending on the location of the dipole and other relevant physical parameters. Therefore, the decay rate can be enhanced in a nanoscale probe 112 with controlled position of the emitting organic film 124. Such a decay rate change will lead to a change in the bias current of the probe 112, which can be detected quantitatively.

The distance from the tip 121 of the probe 112 to the sample 111 can affect the strength of the coupling to different decay mechanisms, which can cause a change in the OLED bias current for a given voltage, as generally shown in FIG. 3. While various theories have been used to study the decay rate of an exciton that is modified by the presence of a metal surface, in the present embodiment, the exciton is viewed as a classical dipole oscillator; however, the discussion provided herein should not be limiting as to the mechanism or principles of operation of the probe 112. The decay rate of an excited dipole can be modified by boundary conditions such as the dielectric constant of the material of the other side of the metal cathode or the thickness of free space between the metal cathode and the dielectric material. This decay rate change can induce the perturbation in current of the device.

In one embodiment, to examine the effect, the following continuity equation for excitons, including generation, diffusion, and decay, is employed,

$$\frac{d {N}_{ex}}{d t} = r ( x ) n ( x ) p ( x ) + {D}_{s} \frac{{d}^{2} {N}_{ex}}{d {x}^{2}} - {b}_{tot} {N}_{ex}$$

where r is the Langevin recombination rate coefficient, n the density of electron, p the density of the hole, Dₛ is the diffusion coefficient, and bₜₒₜ is the total decay rate of excited dipole. The total decay rate includes the radiation, wave guided, SPPs, and loss to electrode modes. If the total decay rate increases, more electron and hole carrier pairs are needed at a given voltage to make up the additional vacant space for excitons and to maintain the steady-state number density of excitons. The fact that current change is proportional to the decay rate change makes it possible to compute the current change quantitatively. The distribution of number density of excitons across the layers can be estimated from an OLED electrical transport simulation, which includes charge injection, transport, recombination, and barriers at organic internal interfaces.

Further, in one embodiment, the cathode 126 and/or anode 120 are composed of several layers of metal, which lowers the energy barrier with the organic film 124. Devices and multilayer structures deposited on planar (i.e., non-probe tip) substrates 118 can be used to analyze the characteristics of dipole decay rates in various situations. In one embodiment, the dielectric constants of each layer can be adopted to be 520 nm, which is the emission wavelength of Alq₃, and those of the organic film 124 are unified as 3 to thereby reduce asymmetric effects.

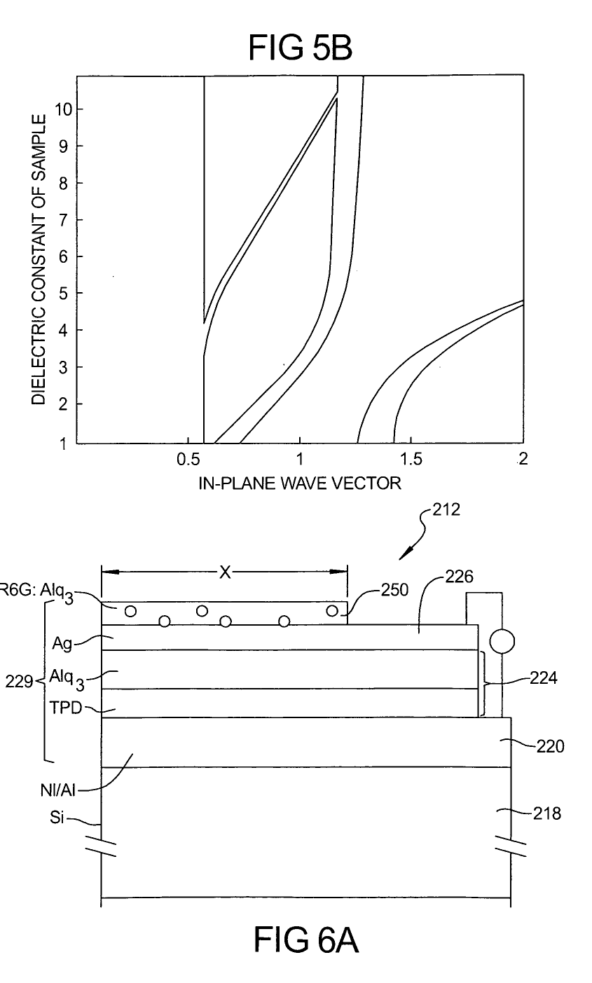

FIG. 5A represents a total decay rate of dipole varying with the thickness of the ETL 127 with a fixed thickness of the HTL 125. The maximum and minimum point of each curve in FIG. 5A moves to left as the thickness of the ETL 127 increases, which is due to the phase change of retardation. The magnitude of oscillation decreases with the distance from the emitter to the metal due to wave attenuation in the organic film 124. For the desired range of dielectric constant, the thickness of the ETL 127 is selected to make the trend monotonically increasing or decreasing. For example, a 60 nm ETL layer 127 can be used for detecting the dielectric constant around three.

To assess reasons for the decay rate alteration, power dissipation spectrum can be integrated as shown in FIG. 5B. FIG. 5B shows the power dissipation mode as a function of dielectric constant of the sample layer with no free space and in-plane wave vector at D=60 nm. Bright regions in FIG. 5B represent high rates of power dissipation, corresponding to fast decay into waveguided, plasmon, and leaky modes.

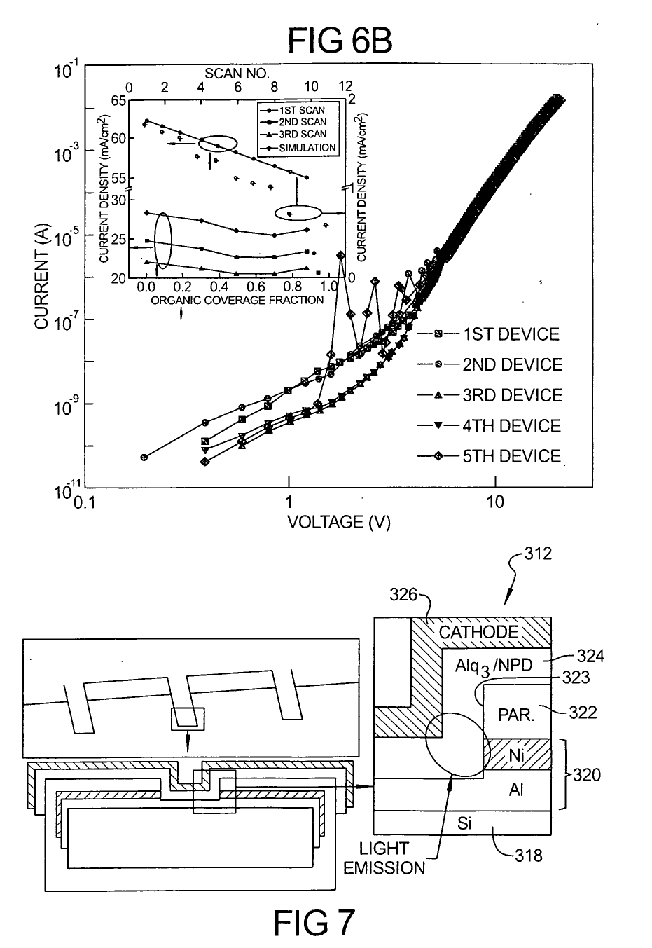

Referring now to the embodiment shown in FIGS. 6A-6C, the energy transfer through the thin metal film to an organic capping layer 250 (e.g., Alq₃:R6G) is shown as effecting the current change in the OLED 229. Control samples with several organic coverage fractions (x=0, 0.3, 0.5, 0.7, 0.9) are shown. The structure of OLEDs 229 on the prototype probe 212 is similar to the common top-emitting OLEDs; however, a surface plasmon supporting metal (e.g., silver) is deposited instead of a typical transparent cathode. In this embodiment, the devices are fabricated by vacuum thermal evaporation system with a base pressure of 10⁻⁷ torr.

Prior to loading into a vacuum system, the silicon substrates 218 are cleaned in a known manner (e.g., according to the method described in Burrows et al in the J. Appl. Phys. 79, 7991 (1996)). Then, the substrates 218 are deposited with the anode 220 material (e.g., a 300 Å thick Al layer followed by a 50 Å thick Ni layer). Next, the substrates 218 coated with the anode 220 are exposed to a flux of UV light and ozone at 20 m W/cm² for 5 min to form a relatively thin conductive layer of Ni oxide, which has an ideal work function for hole injection. Then, the substrates 218 are loaded into the vacuum evaporation system again, and the organic film 224 (e.g., 500 Å TPD and 600 Å Alq₃) and a metal cathode 226 (e.g., 10 Å LiF, 20 Å Al, and 300 Å silver) are deposited at a growth rate from 1 Å/s to 3 Å/s. Then, a 500 Å thick Alq₃ organic capping layer 250 with 5 atomic % R6G is deposited on the top of the cathode 226.

In this embodiment, the capping layer 250 is an organic capping layer 250 that impacts the current of the OLED on the scanning probe 112. The current-voltage relationship of the OLED is measured using a semiconductor parameter analyzer (HP 4156B) while the probe 212 position is fixed. The current through the structure is calculated with steady-state assumption, and therefore constant exciton density at a given voltage is obtained. The hole and electron densities from OLED simulation are used for estimating the exciton density at the emitting layer, in which the decay rate is calculated by considering reflection from the multi layer with given boundary conditions. The simulated I-V curve is fitted to the experimental data by shifting a constant voltage to consider the interfacial dipole at the organic-metal interface, which affects the cathode work function and changes the energy barrier for the injection model. Furthermore, in one embodiment, a degradation effect from cathode oxidation is accounted for.

FIG. 6B shows the effect of organic coverage on the OLED bias current from experiments and calculation. The current-voltage curves of the probes 212 with different organic coverage are shown. FIG. 6C illustrates the current densities of the different probes 212 at 15V to compare the effect of the capping layer 250 on the current. Meanwhile, the current densities at 15V of the same device without the organic capping layer 250 are also plotted as the function of scan number to show the degradation during the test. As shown, the current density decreases as the organic coverage fraction increases. The decay rate of the organic film 224 and hence the current through the probe 212 can be changed by the fraction of SPPs mediated energy transfer into the organic capping layer 250. Accordingly, the probe 212 of the present disclosure is useful in the practical application of characterizing the optical properties of materials in nanoscale.

FIG. 7 shows a cross-sectional view of the emissive region of another embodiment of the scanning probe 312. In this embodiment, an anode 320 comprising 100 nm thick aluminum, capped by 13 nm of nickel is thermally evaporated onto a tipless Si silicon 318 having a nominal width, length and thickness of 35 μm, 90 μm, and 2 μm respectively. Furthermore, the insulating layer 322 (e.g., a conformal 800 nm thick layer of PARYLENE-C™) is vapor-deposited over the anode 320. The hole 323 on the cantilever is formed by milling the insulator layer with a focused gallium ion beam (FEI 3D Dual Beam FIB), with an accelerating field for the Ga⁺ ion at approximately 20 kV and an applied current of approximately 0.76 nA. In one embodiment, the material within the milled hole 323 is characterized using Energy Dispersive X-ray (EDX) detection, making it possible to effectively mill through the insulating layer 322 and only a predetermined portion of the anode 320.

Following the beam lithography step, the layers of the active organic film 324 are deposited by thermal evaporation at 10⁻⁷ Torr. In this embodiment, the organic film 324 includes a hole transporting layer comprising a 50 nm thick N,N′-di-[(1-naphthalenyl)-N,N′-diphenyl]-(1,1′-biphenyl)-4,4′-diamine (α-NPD), and an electron transporting and emissive layer comprising a 60 nm thick tris(8-hydroxyquinoline) aluminum (Alq₃). The cathode 312 is also included, comprising a 0.5 nm thick layer of LiF, followed by a 1 nm thick layer of aluminum, and an 18 nm thick layer of silver.

A control sample 360 is prepared having a layer structure identical to that of the probe 312, but without the hole 323. As such, the anode 320 of the control sample 360 is electrically disconnected and separated from the organic film 324 by the respective insulator 322.

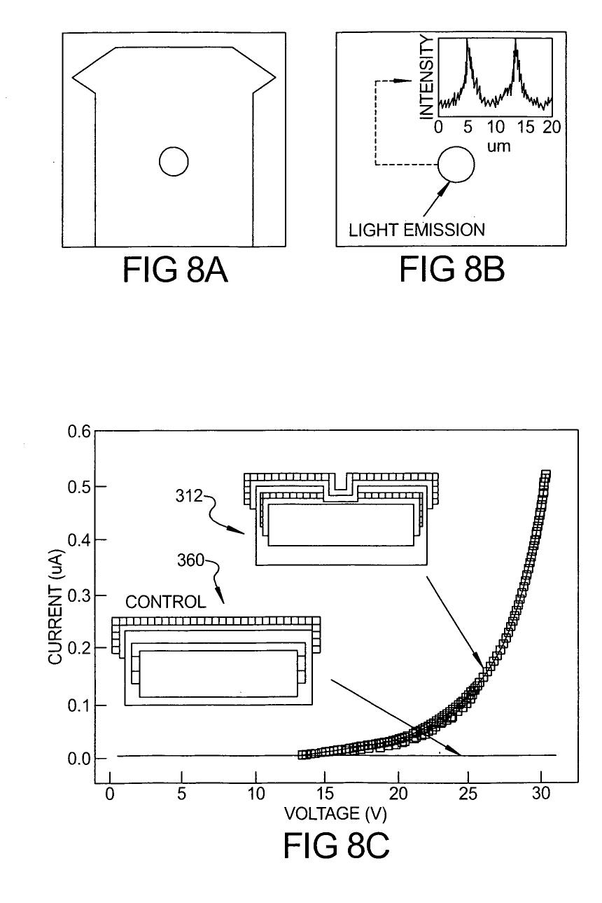

Electroluminescence (EL) from the OLED on the cantilevered probe 312 is detected through an upright microscope with a long working distance (20.5 mm) objective (50×, numerical aperture of 0.42) that facilitates making electrical connections to the device electrodes 320, 326. To image light emission, a sensitive charge-coupled device (CCD) camera is utilized in a dark room. FIG. 8A shows the CCD image of the OLED near the end of the tipless cantilever under external illumination. The dark ring indicates the walls of the milled region. FIG. 8B shows the EL image of the OLED in FIG. 8A under forward bias. The EL emission is ring-shaped even though the hole 323 is disk-shaped, because holes at the anode 320 are preferentially injected from the nickel due to it having a higher work function than aluminum. As shown in FIG. 7, the milling process removes the top nickel layer from the anode 320, leaving a ring-shaped region for hole injection from the nickel on the edge of the milled region into the organic film 324.

The far-field light captured by the CCD is a combination of primarily the wave-guided emission along the sides of the hole 323 and the scattering from the bottom of the hole 323. The inset of FIG. 8B shows the EL intensity profile measured along the dashed line. The full-width half-maximum (FWHM) of each peak of the emission is 1.8 μm and 1.4 μm, respectively, as measured in the far-field. Near-field enhancement of imaging resolution may occur at the top of the hole 323, in proximity to the rim, due to the efficient coupling of energy from the electrically-pumped dipoles to surface plasmon polariton modes that can propagate along the metal-organic interface. The near-field coupling of plasmon modes to a sample can occur at the rim of the hold 323, in a manner analogous to that in apertureless SNOM.

Each of three cantilevers (see FIG. 7) contains an OLED in accordance with the principles of the disclosure, and each OLED has an identical size and shares a common anode 320 and a common cathode 326. All three devices are thus connected in parallel, and all emit light simultaneously. FIG. 8C compares the current-voltage (I-V) characteristics of the ring-shaped OLEDs on the probes 312 with the control sample 360, and both are measured during optical testing using an Agilent 4156B semiconductor parameter analyzer. Current passes through the OLED devices, and the leakage current (i.e., the current through the control sample 360) is very small. The device emission and I-V characteristics shown in FIG. 8C are similar for other sets of cantilever probes.

Such a device, prepared in accordance with various principles set forth in the present disclosure, can be used for a wide range of new probing techniques. The wavelength of emitted light can be tuned across the entire visible spectrum, including white light emission, by altering the composition of the organic film 324. If a ring-shaped light emission is used for imaging, the sample image can be deconvolved using a ring filter to achieve high resolution.

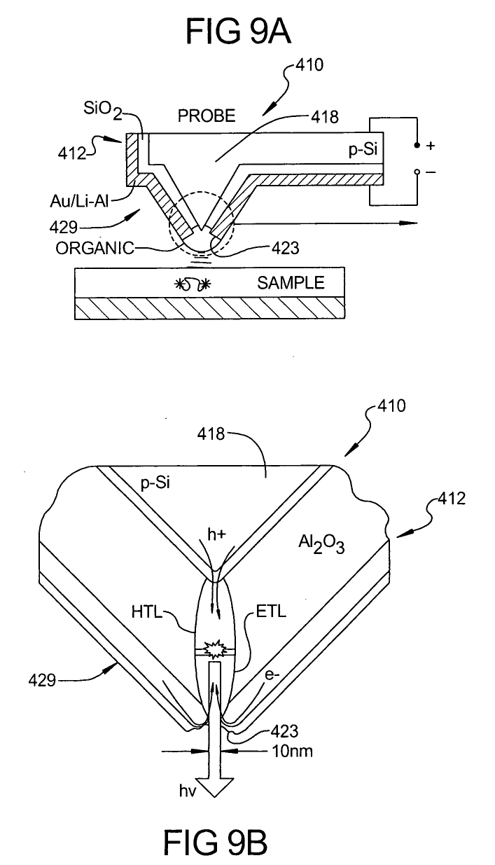

Referring now to FIGS. 9A and 9B, another embodiment of an electrically pumped OLED 429 is illustrated for a probe 412 of a scanning device 410. In the embodiment shown, the materials of the heterojunction OLED 429 are deposited inside of a cylindrical hole 423. In the embodiment shown, the hole 423 measures approximately 10 nm in diameter and 100 nm in height. The hole 23 is etched into the vertex of an atomic force microscope tip 416.

Electrical pumping of the probe 412 enables on-demand generation and transfer of photons, singlet and triplet excitons to the substrate 418. The structure, material selection, and sequential fabrication approach ensures a 10 nm or better spatial resolution of the probe 412, and the capability to function in both steady-state and short-pulse modes. The probe 412 also achieves better resolution with less probe heating than aperture-based NSOM. Moreover, the probe 412 reduces the noise due to sample irradiation in optically pumped probes such as apertureless NSOM.

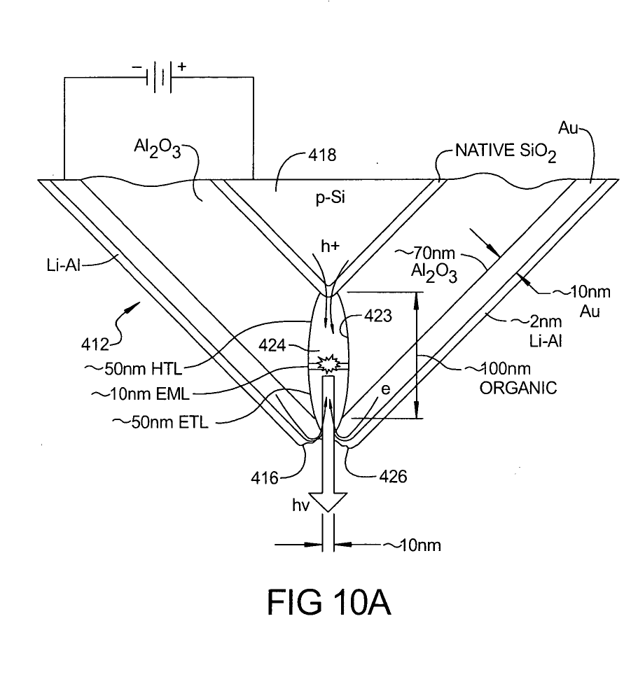

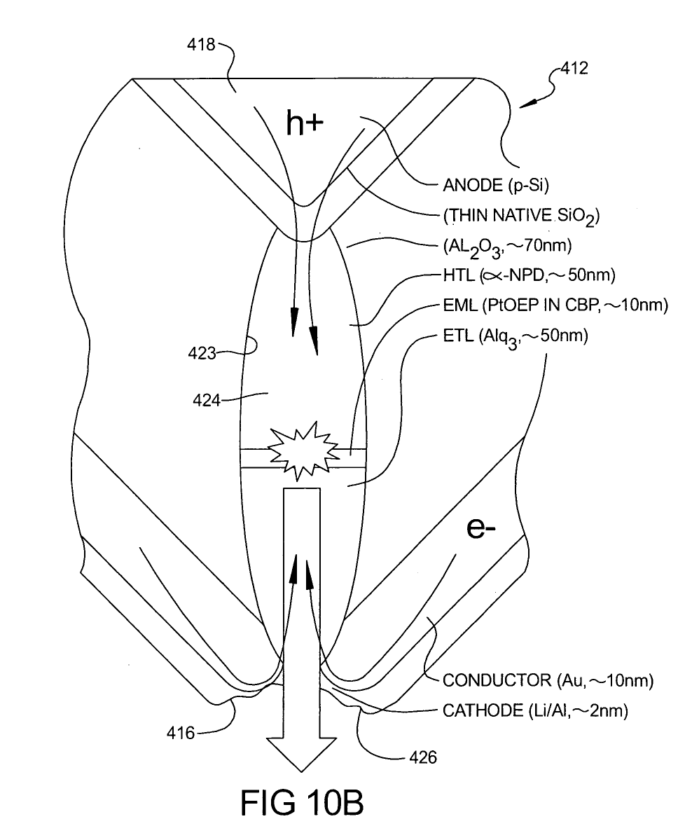

Referring now to FIGS. 10A and 10B, the probe 412 is shown in more detail. The probe 412 includes an AFM/STM tip 416 modified into an OLED 429 to enable the transfer of light and excitons to a sample (not shown). It will be appreciated that the embodiment of FIGS. 10A and 10B is merely one configuration, and several variations are possible.

Here, the tip 416 is a pyramid-shaped projection and includes p-doped silicon substrate 418 coated with layers of Al₂O₃ and gold (Au). In one embodiment, the Al₂O₃ is approximately 70 nm thick, and the gold (Au) layer is approximately 10 nm thick. The hole 423 extends through the Al₂O₃ and encapsulates the organic material 424. In one embodiment, the organic materials 424 are provided in the hole 423 by organic vapor jet printing and/or pressure-inducing filling operations.

The tip 416 is capped by a cathode 426 made of Li—Al. In one embodiment, the cathode 426 is approximately 2 nm thick. The substrate 418 is operable as a hole injecting anode. Excitons are generated in the organic material 424. The OLED 429 itself is an archetypal OLED structure like those described above but with a generally cylindrical shape and a diameter smaller than its thickness.

The vertical nano-OLED 429 of FIGS. 10A, 10B has thicker layers that are less susceptible to contamination and heat damage during the deposition of the metal contact, resulting in a more robust and stable device. Furthermore, the thick Al₂O₃ layer has a lower refractive index than the organic material 424 (e.g. n=1.6 vs. 1.8 or higher), confining the optical mode laterally and thereby improving the light outcoupling efficiency.

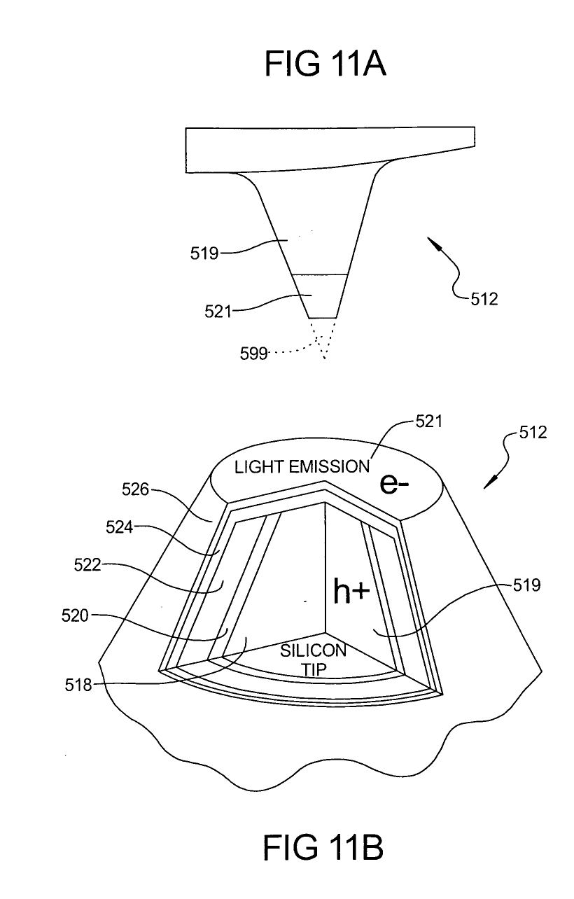

Referring now to FIGS. 11A and 11B, one embodiment of a fabrication process for a probe 512 is illustrated. The probe 512 is substantially similar to the probes 112, 412 described above. In the embodiment shown, the probe 512 includes a projection 519 having a tip 521.

In order to fabricate the probe 512, the substrate 518 with the projection 519 formed thereon is layered with the anode 520. Then, the insulating material 522 is layered on the anode 520. Next, an end 599 is removed (as illustrated in broken lines in FIG. 11A) to thereby remove a portion of the insulating material 522, the anode 520, and the substrate 518. In one embodiment, the end 599 is removed using a focused ion beam (FIB) to truncate the end 599. This leaves a portion of the anode 520 exposed. Subsequently, the organic material 524 is layered thereon so as to be electrically connected to exposed anode 520, and then the cathode 526 is layered thereon.

It will be appreciated that the amount of material removed from the end 599 can be controlled to thereby control the size of the active region of the probe 512. Accordingly, the resolution of the probe 512 can also be controlled.

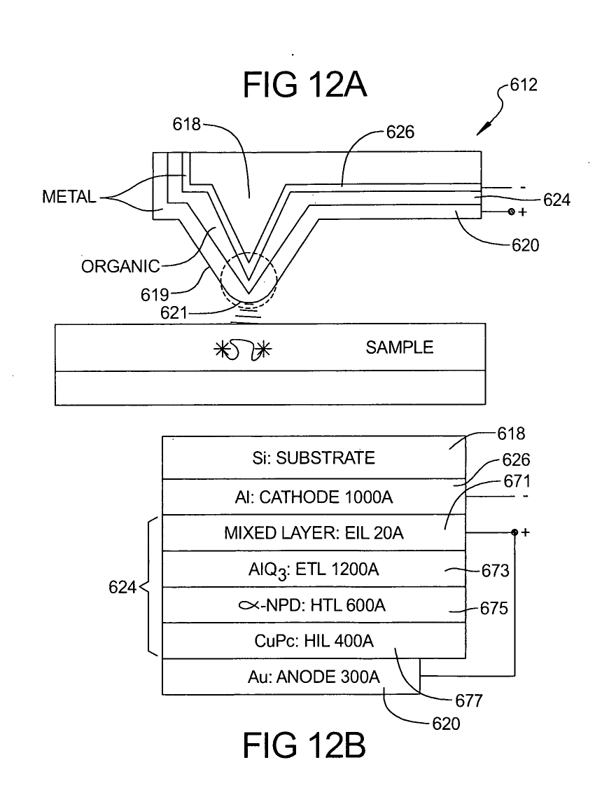

Referring now to FIGS. 12A and 12B, another embodiment of the probe 612 is illustrated. The probe 612 is an electrically pumped nano-scale light source.

In the embodiment shown, the probe 612 includes a projection 619 having a tip 621. As shown in FIG. 12B, the probe 612 includes a substrate 618 made of silicon. Also, in this embodiment the cathode 626 is layered on the substrate 618. In one embodiment, the cathode 626 is made of aluminum. The organic material 624 includes a plurality of layers. For instance, in the embodiment shown, the probe 612 includes a mixed layer 671 of Al, LiF, and Alq₃, a layer 673 of Alq₃, a layer 675 of α-NPD, and a layer 677 of CuPc layered on the cathode 626. Finally, the anode 620 is layered thereon. In one embodiment, the anode 620 is made of gold (Au).

Under forward bias, holes and electrons are injected from the anode and cathode 620, 626 and recombine inside the organic material 624, emitting photons through the anode 620, which is semi-transparent. At low bias, charge conduction occurs. The onset of light emission in the probe 612 occurs at a higher bias, the transition to which has a strong threshold behavior with voltage. The threshold voltage, in turn, increases according to the thickness of the organic material 624, and this effect can be utilized to control the location of light emission.

In one embodiment, the probe 612 is fabricated by virtue of using vacuum thermal evaporation to deposit materials on the non-planar substrate. This allows formation regions of confined charge injection and emission. The vacuum thermal evaporation processes are carried out instead of lithographic processes on the tips and deposited films. The vacuum thermal evaporation process has a line-of-sight molecular transport characteristic, which allows for controlled thickness variation across the non-planar substrate, such that localized current injection occurs at the tip 621.

More specifically, the substrate 618 is positioned in front of a molecular flux from a resistively heated cell (not shown) and rotated. Then, the layers 620, 626, 671, 673, 675, 677 are deposited sequentially by being evaporated from the heated cell (not shown) onto the previously deposited layer. Due to the rectilinear molecular trajectories during this process, the layer thicknesses vary with the angle of incidence of molecules on the surface, resulting in thinner layers on the sloping sides of the projection 619 compared to the areas surrounding the projection 619. Under constant bias, the current density in the projection 619 is higher than that in the area surrounding the projection 619, allowing the projection 619 to pass higher current, while the areas surrounding the projection 619 pass lower current at the same bias.

It will be appreciated that the probe 612 can also be designed to be one in which the curvature of the tip 621 serves to concentrate electric field, assisting in carrier injection into the coating.

In summary, such scanning probes 12, 112, 212, 312, 412, 512, 612 including the OLED device mounted on the cantilever, are useful for various scanning devices, such as SNOM. The scanning probes 12, 112, 212, 312, 412, 512, 612 can also work as an exciton injector for measuring the dissociation characteristic or can be combined with the microscope to detect the transferred energy, which is related to the photonic states in organic materials.

For example, in certain aspects, the scanning probes 12, 112, 212, 312, 412, 512, 612 can be employed to detect photon generation, for example in array structures for bio-assays having fluorescent tags that indicate the presence or absence of certain moieties and/or chemicals. In summary, the present disclosure will have numerous applications in material science and bio-sensing arts.

Moreover, the fabrication techniques disclosed herein can also be utilized for a variety of cantilever substrates 18, 118, 218, 318, 418, 518, 618 including those comprising silicon and silicon nitride. The OLED probe 12, 112, 212, 312, 412, 512, 612 can also be used to transfer excitons through the cathode 326 to a sample via plasmon-assisted energy transfer, which is valuable for studying exciton dynamics in organic or organic/inorganic hybrid photovoltaic devices.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A probe for a scanning device comprising:
an anode;
a cathode; and
an organic material disposed between the anode and the cathode, the organic material being operable for at least one of emitting and detecting light by an electrical bias applied between the anode and cathode.

2. The probe according to claim 1, wherein the organic material is an electroluminescent organic material.

3. The probe according to claim 1, wherein the organic material is an optically absorbing organic material.

4. The probe according to claim 1, wherein the organic material comprises a plurality of layers.

5. The probe according to claim 1, wherein the organic material is a single layer.

6. The probe according to claim 1, wherein the organic material is provided by at least one of vapor deposition, vacuum deposition, pulsed laser deposition, dip-coating, and vacuum thermal evaporation.

7. The probe according to claim 1, wherein the organic material is electrically pumped, and the organic material generates excitons.

8. The probe according to claim 1, wherein the organic material generates excitons and transfers energy to a sample via surface plasmon polaritons.

9. The probe according to claim 4, further comprising at least one of a hole transporting layer, an electron transporting layer, and an exciton blocking layer disposed between the cathode and the anode.

10. The probe according to claim 1, further comprising an insulating layer disposed between the organic material and at least one of the anode and the cathode.

11. The probe according to claim 10, wherein the insulating layer includes a hole, and wherein the organic material is provided in the hole so as to be in electrical communication with at least one of the anode and the cathode.

12. The probe according to claim 1, wherein the organic material comprises at least one of N,N′-di-[(1-napthalenyl]-N,N′-diphenyl]-(1,1′-biphenyl)-4,4′-diamine) (α-NPD), N,N-diphenyl-N,N-di(3-methylphenyl)-1,1-biphenyl-4,4,-diamine (TPD), tris(8-hydroxyquinoline aluminum (Alq₃), platinum octaethyl porphorin (PtOEP), and iridium-pyridine (Ir(ppy)₃).

13. A method of forming a probe for a scanning device that at least one of detects and emits light, the method comprising:
providing a substrate; and
depositing an organic material on the substrate via a process selected from a group consisting essentially of vapor deposition, vacuum deposition, pulsed laser deposition, dip-coating, vacuum thermal evaporation, and a combination thereof.

14. The method of claim 13, further comprising disposing an electrode supported by the substrate.

15. The method of claim 14, wherein the depositing the organic material comprises depositing the organic material in electrical contact with the electrode.

16. The method of claim 14, wherein the providing the electrode comprises providing a first electrode supported by the substrate, and further comprising depositing a second electrode having an opposite polarity to the first electrode over and in electrical contact with at least a portion of the organic material.

17. The method of claim 13, further comprising disposing an electrically insulating material on the electrode.

18. The method of claim 17, further comprising providing a hole in the electrically insulating material by a process selected from a group consisting of focused ion beam milling, electron beam lithography, laser drilling and a combination thereof.

19. The method of claim 13, wherein the organic material comprises a plurality of layers of different material deposited sequentially.

20. A scanning device comprising:
at least one probe having an anode, a cathode, and an organic material positioned between the anode and the cathode, the organic material being operable for at least one of emitting and detecting light due to at least one of charge injection to and separation from the anode and the cathode.

21. The scanning device according to claim 20, wherein the scanning device is at least one of an atomic force microscopy (AFM) scanning probe microscope and a scanning near field optical microscope (SNOM).

22. The scanning device according to claim 20, wherein the probe comprises a projection, the organic material being disposed on the projection.
